(19) United States
(12) Patent Application Publication
(10) Pub. No.: US 2006/0048714 A1
(43) Pub. Date: Mar. 9, 2006

(54) Method and system for breeding fry

(76) Inventors: Shigeki Kamigauchi, Tsukuba-shi (JP); Toru Sakimura, Kobe-shi (JP); Satoko Uchida, Kobe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/514,484

(22) PCT Filed: May 15, 2003
(86) PCT No.: PCT/JP03/06056

§ 371 Date: Jun. 30, 2005

(30) Foreign Application Priority Data
May 17, 2002 (JP) 2002-142812

(51) Int. Cl. A01K 61/00

(52) U.S. Cl. 119/217

(57) ABSTRACT

Fry breeding method and apparatus are provided by which growth irregularity and lethal rate are reduced and a remarkably quick growth is enabled. A closed type fry breeding water tank 1 has a fry isolating function by meshes 1b, 1c. Breeding water prepared to have a high dissolved oxygen concentration by an artificial lung 3 is supplied into the fry breeding water tank 1 in a low flow rate that has little influence on the fry. The fry, especially those immediately after the hatching on which the dissolved oxygen is very influential, are bred in the streaming water, not in the stationary water as so far considered a common sense in the conventional case. Thereby, the growth irregularity that has so far not been overcome is suppressed and a remarkably quick, safe and secure growth is enabled.

### TECHNICAL FIELD

The present invention relates to a fry breeding method and apparatus by which fry, especially those immediately after the hatching, to be bred in a fry breeding carried out in many fields of biological researches, fish breeding, etc. are remarkably quickly, safely and securely grown by circulating breeding water of a high dissolved oxygen concentration into a closed type breeding water tank in a low flow rate.

### BACKGROUND ART

Conventionally, in breeding small fish, such as medaka, zebra fish and the like, for a research purpose, it is a usual method that the breeding of fry immediately after the hatching is carried out in a stationary water condition by using a small size water tank, etc. and then, at the stage that they have grown to some extent, they are moved into a circulation type water tank to be bred in a streaming water condition. It is generally known that fish are weak against a shortage of oxygen and thus to maintain a dissolved oxygen concentration in the breeding water is an important factor also in the fry breeding.

However, the fry immediately after the hatching are very weak against a water stream so that no maintenance of the dissolved oxygen concentration can be done by air bubbling, air injection by streaming water, etc. Hence, various methods of the breeding in the stationary water condition are being carried out such that a vessel having a wide water surface or a vessel having a shallow water depth so that oxygen is easily dissolved into the breeding water is used or the density of the fish to be bred is reduced. The fry are first bred in the stationary water condition and, after they have grown to some extent, they are moved into the circulation type water tank in which maintenance of the dissolved oxygen concentration or maintenance of the water quality can be easily done by air injection by the streaming water.

While the above-mentioned method is widely carried out, it is generally known that the lethal rate of the fish to be bred in the stationary water condition is highest in the fry breeding time of about 2 weeks immediately after the hatching and also that the growth in this time gives a large influence on the subsequent growth and development. In the breeding of small fish for a research purpose, it is important to shorten the breeding time of one generation to the extent possible. Hence, it is currently a large problem how the lethal rate at this time is reduced and how the growth is promoted.

In the prior art fry breeding so far carried out in the stationary water condition, while the dissolved oxygen concentration in the breeding water is highest in the vicinity of the water surface, it becomes lower corresponding to the water depth. For this reason, while such a vessel as has a wide water surface and shallow water depth is used, as the dissolved oxygen concentration in the breeding vessel is low as a whole, the growth of the fry is slow and irregularity of the growth is caused. Moreover, death of the fish is often seen.

### DISCLOSURE OF THE INVENTION

In order to overcome the basic problems in the prior art fry breeding method, it is an object of the present invention to provide a fry breeding method and apparatus by which a high dissolved oxygen concentration is realized in an entire area of the breeding water tank so as to give no bad influence on the fry and thereby the irregularity of the growth and the lethal rate are reduced and a remarkably quick, safe and secure growth is enabled.

In order to solve the above-mentioned object, the present invention provides a fry breeding method comprising the step of quickly, safely and securely growing fry by circulating breeding water prepared to have a high dissolved oxygen concentration in a closed type water tank.

It is preferable that the breeding water of the present invention is prepared to have a high dissolved oxygen concentration of 80% or more of a saturated value of the dissolved oxygen concentration.

It is reported in many fields that a high dissolved oxygen has generally a large influence on the activity of living things. The present invention makes use of this general principle. That is, the fry, especially those immediately after the hatching on which the dissolved oxygen is very influential, are bred in the streaming water, not in the stationary water as so far considered a common sense in the conventional case, wherein the breeding water is prepared to have a high dissolved oxygen concentration, preferably of as high as 80% or more of the saturated value of the dissolved oxygen concentration, by a transmembrane technique as represented by an artificial lung and this breeding water is circulated so that the oxygen concentration is enhanced uniformly in the entire water tank. Thereby, the irregularity of the growth that has so far not been overcome in the conventional case is suppressed and a remarkably quick, safe and secure growth of the fish is enabled.

Also, the present invention provides a fry breeding apparatus comprising a means continuously supplying breeding water into a closed type breeding water tank to flow therein in a flow velocity of 0.1 to 3 mm/second and a means enhancing a dissolved oxygen concentration of the breeding water.

It is preferable that the closed type breeding water tank is a closed type breeding water tank having its inlet side and outlet side provided with an isolating means, such as a mesh, etc., so that the fry are prevented from escaping from the water tank as well as the flow velocity in the water tank is made uniform by the arrangement of the mesh, etc.

In the fry breeding apparatus of the present invention, it is also preferable that a filter device filtering off residual foods, etc. of the breeding water is provided downstream of the breeding water tank. Thereby, while the water tank is maintained in the closed state as it is, the residual foods, etc. in the water tank can be removed.

According to the fry breeding apparatus of the present invention so constructed, the above-mentioned fry breeding method of the present invention can be easily practiced.

Moreover, in the fry breeding apparatus of the present invention, it is preferable that the means enhancing the dissolved oxygen concentration of the breeding water is an artificial lung and an entire system of the breeding water is made in a closed type. Thereby, the fry breeding apparatus of the present invention can be used even in a micro-gravity condition in the space.

### BRIEF DESCRIPTION OF THE DRAWINGS

FIG. 1 is an explanatory view showing a breeding water circulating system for breeding fry as a first embodiment (a closed type circulation system) according to the present invention.

FIG. 2 is an explanatory view showing a breeding water circulating system for breeding fry as a second embodiment (an open type circulation system) according to the present invention.

FIG. 3 is an explanatory view showing a breeding water circulating system for breeding fry as a third embodiment (air bubbling is carried out in the open type circulation system) according to the present invention.

FIG. 4, being photographs showing the actual test states for explaining the effect of the present invention, comprises FIGS. 4(a) to 4(c) showing the following states; FIG. 4(a): test start time, FIG. 4(b): 6th day of the test start and FIG. 4(c): 12th day of the test start.

FIG. 5, being photographs showing the actual test states for explaining the effect of the present invention, comprises FIGS. 5(a) to 5(c) showing the following states; FIG. 5(a): 16th day of the test start, FIG. 5(b): 21st day of the test start and FIG. 5(c): 26th day of the test start.

FIG. 6, being photographs showing the actual test states for explaining the effect of the present invention, comprises FIGS. 6(a) to 6(c) showing the following states; FIG. 6(a): 30th day of the test start, FIG. 6(b): 36th day of the test start and FIG. 6(c): 42nd day of the test start.

FIG. 7 is a photograph showing the actual test state for explaining the effect of the present invention and shows the state of the 46th day of the test start.

FIG. 8 is a graph showing data of dissolved oxygen concentration and temperature of the breeding water measured in the tests of FIGS. 4 to 7.

FIG. 9 is an explanatory view of a set-up of the tests of FIGS. 4 to 7.

### BEST MODE FOR CARRYING OUT THE INVENTION

Herebelow, a fry breeding method according to the present invention will be concretely described based on embodiments as illustrated.

### First Embodiment

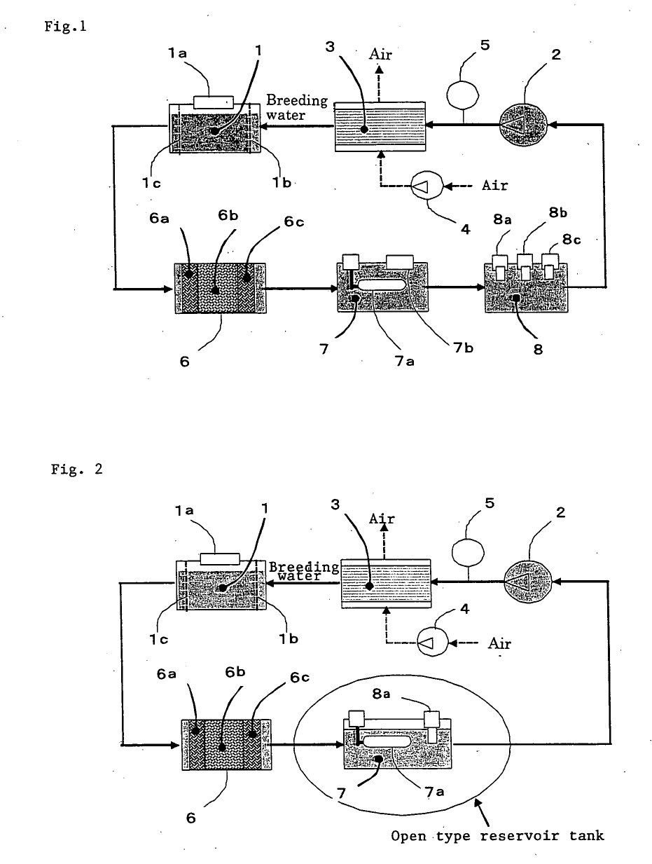

A first embodiment according to the present invention will be described with reference to FIG. 1. The present first embodiment is made in a closed system. In FIG. 1, a fry breeding water tank 1 comprises an access port 1a, an inlet side mesh 1b and an outlet side mesh 1c. The access port 1a is an opening portion of the water tank through which the fry are taken in or taken out or fed or cleaning of the water tank is carried out. While the inlet side and outlet side meshes 1b, 1c are provided so that the fry cannot escape from the water tank, they have also a function to make the flow velocity of the breeding water in the water tank uniform.

The fry generally require air phase for swelling their air bladders and, for this purpose, air phase is provided in an upper portion of the water tank. In order to supply the breeding water of a high dissolved oxygen concentration into the fry breeding water tank 1, a breeding water pump 2 and an artificial lung 3 are connected to the fry breeding water tank 1. Usually, an artificial lung comprises a porous membrane provided therein so that an oxygen containing gas is flown on one side of the porous membrane and water is flown on the other side of the porous membrane and thereby oxygen is supplied into the water via the porous membrane. In the case of the artificial lung 3, it is supplied with air from an air pump 4 and, via a tube made by the porous membrane, oxygen is supplied into the breeding water that is supplied by the breeding water pump 2.

Numeral 5 designates a flow rate sensor detecting a flow rate of the breeding water and numeral 6 designates a waste filter as a filtering device for catching residual foods, excrements, etc. coming from the breeding water tank. In the waste filter 6, an inlet side filter cloth 6a, a chemical adsorption filter material (an activated carbon, etc.) 6b and an outlet side filter cloth 6b are provided.

A reservoir tank 7 of closed type for controlling water temperature and a sensor box 8 for measurements of temperature, pH, DO (dissolved oxygen), etc. are connected to the downstream side of the waste filter 6. The sensor box 8 comprises a temperature sensor 8a, a pH sensor 8b, a DO sensor 8c and the like.

In the reservoir tank 7, a heater 7a for controlling the temperature and an access port 7b for exchanging the breeding water, etc., when needed, are provided.

If the system is made in an open type in which air bubbling is carried out in an outwardly opened tank, to maintain the dissolved oxygen concentration of almost the saturation state is difficult.

It is to be noted that the flow rate of the breeding water is to be decided from the viewpoint of the minimum flow rate that has no bad influence on the fry but still enables a temperature control or sensor measurement of the water quality or from the view point of the range that makes the feeding possible. Hence, in the test examples described later, where an entire water quantity in the system is 4.4 liter and a water tank inner volume is about 700 cc, the flow rate of the breeding water is set to 0.1 liter/min. This flow rate corresponds to a linear flow velocity of 0.2 mm/sec in the test water tank and has no problem given on the fry of medaka. According to the experiments done by the inventors here, by continuously supplying the breeding water of a high dissolved oxygen concentration into the closed type breeding water tank in a flow velocity of 0.1 to 3 mm/sec, it is found that the fry immediately after the hatching can be quickly, safely and securely grown.

As mentioned above, in the present first embodiment, by using the closed type of the breeding water system, the dissolved oxygen concentration is efficiently maintained at a high value. Hence, this breeding water system can be used even in the space environment.

In the fry breeding water tank used in the fry breeding method of the present invention, like the fry breeding water tank 1 of the present embodiment, it is necessary to provide the inlet side and outlet side meshes through which the fry cannot pass to thereby prevent the fry from escaping from the water tank. At the same time, these meshes function to make the flow velocity of the breeding water in the water tank uniform.

As to the outlet side mesh 1c, it is preferable that the mesh size is changed according to the extent of growth of the fry. In the case of medaka, the mesh of about 0.3 mm is needed for the fry immediately after the hatching. While the mesh of this size is being used, the residual foods cannot be removed. But, with several days thereafter, the fry grow so as not to be able to pass through the mesh of about 1 mm size. Then, the mesh size is changed to the larger size and the removal of the residual foods by the streaming water becomes possible.

### Second Embodiment

A second embodiment according to the present invention will be described below with reference to FIG. 2. The present second embodiment is made in a system of open type and is different from the first embodiment in the points that the reservoir tank 7 is made in the open type opened toward the surrounding air, the temperature sensor 8a is installed on this open type reservoir tank 7 and the sensor box 8 of the first embodiment comprising the pH sensor 8b, DO sensor 8c, etc. is eliminated.

As the breeding water is prepared in the almost saturated dissolved oxygen concentration by the artificial lung 3, it is preferable that the breeding water system is made in the closed type like the first embodiment. But, if a sufficient oxygen can be supplied into the breeding water according to selection of the artificial lung 3, a portion of the system may be made in the type opened toward the surrounding air as in the present second embodiment. But, in any case, the breeding water tank 1 itself is needed to be made in the closed type.

### Third Embodiment

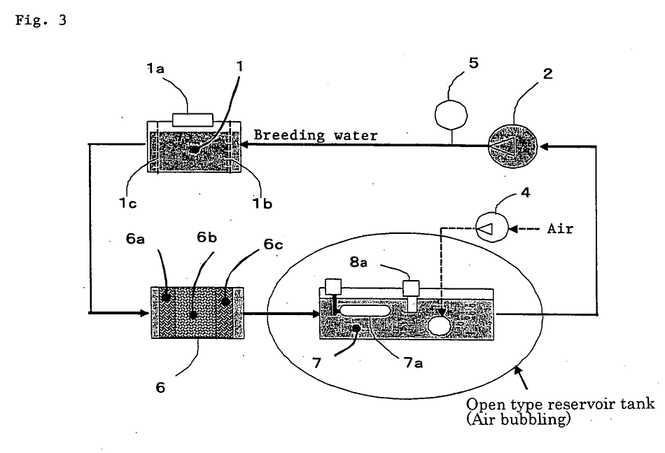

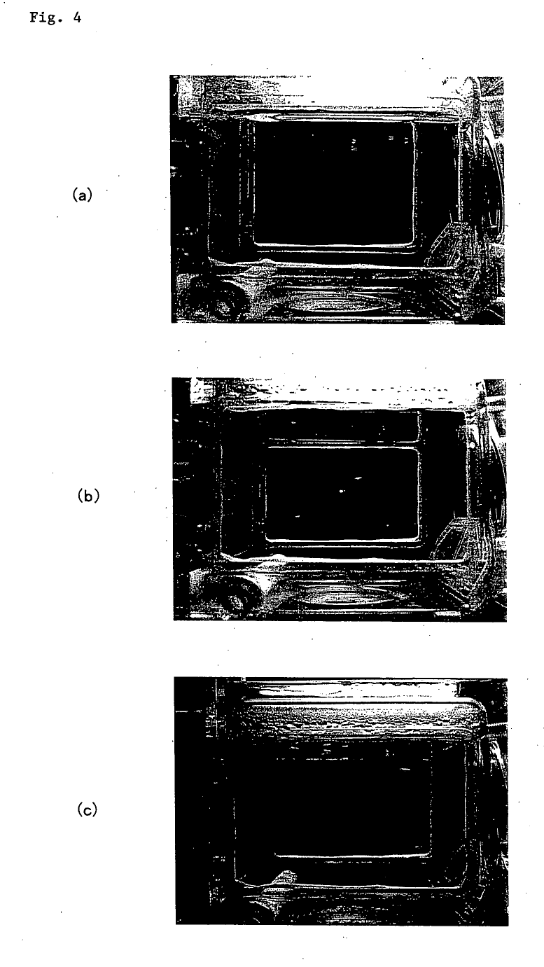

Next, a third embodiment according to the present invention will be described with reference to FIG. 3. This third embodiment is constructed such that, as compared with the second embodiment, the artificial lung 3 is eliminated and the open type reservoir tank 7 is made in an air bubbling type. Other portions of the construction of the third embodiment are the same as in the second embodiment shown in FIG. 2 and are designated with the same reference numerals with repeated description thereon being omitted.

In the present third embodiment, as compared with the case where the artificial lung is used, the dissolved oxygen concentration becomes slightly lower but a simple and less expensive system can be practically provided.

In the above, while the present invention has been described based on the three embodiments having different constructions of the breeding water system, the present invention is not limited to these embodiments but, needless to mention, may be added with various modifications and alterations within the scope of the invention as shown in the appended claims.

For example, while the waste filter 6 has been described as a physical and chemical filter in the embodiments, a biological filter may be included therein according to the usage. Further, if the breeding water temperature can be controlled corresponding to the temperature of the outside environment, the reservoir tank 7 also can be eliminated. Moreover, while the artificial lung is used for supplying oxygen in the above-mentioned embodiments, various air supply technologies by membranes, air bubbling means, etc., other than the artificial lung, may be used.

As mentioned above, the construction of the breeding water system may be appropriately decided corresponding to the usage. The main point of the fry breeding method of the present invention is that the breeding water tank is made in the closed type and that the breeding water of the high dissolved oxygen concentration prepared by air supply technologies by membranes, etc. is supplied into an entire area of the breeding water tank so that the oxygen concentration is uniformly enhanced within the entire water tank.

### INDUSTRIAL APPLICABILITY

According to the fry breeding method and fry breeding apparatus of the present invention as described above, the fry of the time immediately after the hatching when the difference in the growth is most liable to occur are bred in the breeding water of the high dissolved oxygen concentration and low flow rate. Thereby, as compared with the prior art method and apparatus, the fry can be remarkably quickly grown without a substantial difference between each of the fry to be bred. This effect will be described with reference to FIGS. 4 to 7.

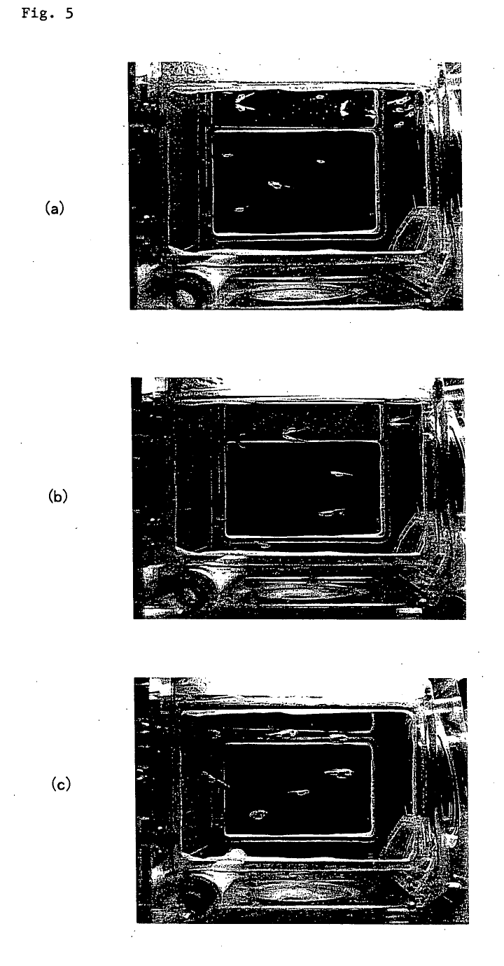

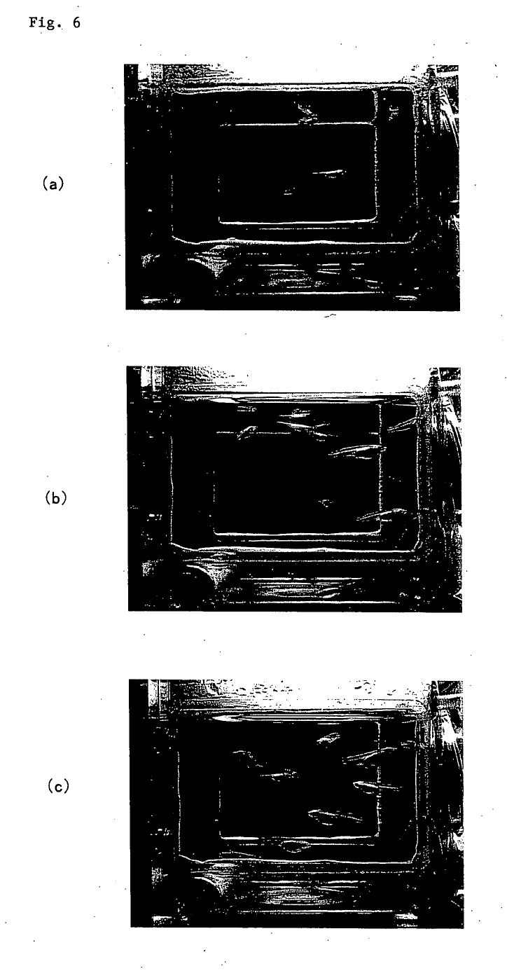

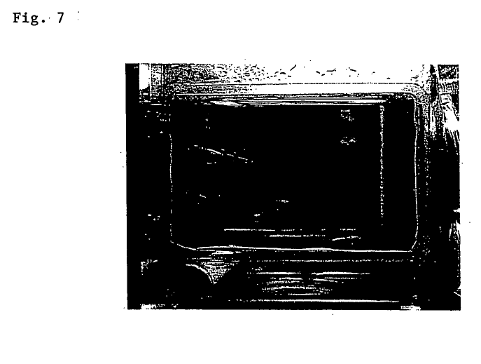

FIGS. 4 to 7 are photographs taken approximately every 5 days of the states where 10 fry medaka immediately after the hatching are actually bred under the environment of the high dissolved oxygen concentration in a closed type water tank having an inner volume of about 700 cc. Each of FIGS. 4 to 6 comprises 3 photographs (a) to (c) and the respective photographs of FIGS. 4 to 7 show the following states; In FIG. 4, (a): test start time, (b): 6th day of the test start, (c) 12th day of the test start. In FIG. 5, (a): 16th day of the test start, (b): 21st day of the test start, (c): 26th day of the test start. In FIG. 6, (a): 30th day of the test start, (b): 36th day of the test start, (c): 42nd day of the test start. FIG. 7: 46th day of the test start.

In the actual tests, two closed type water tanks, arranged in parallel to each other, are used in one system. While the photographs show the states of one water tank out of the two water tanks, the same results have been obtained in the other water tank also. The body length of the fry on the 11th day is 6 to 7 mm and that on the 18th day is 8 to 10 mm. Out of the 10 fish, while 1 or 2 of them had a body length slightly smaller than the other fish, there is no large difference between them. Until the 46th day shown in FIG. 7 when one of the fish spawned, all the fish have grown without dying. In the other water tank also, there has been no death and spawning on the 48th day was observed.

In case of the medaka, spawning of the 46th day or the 47th day after the hatching is the minimum value attainable by using natural foods in the breeding method using a conventional open type water tank. While the present tests use artificial foods only, if natural foods are used, it is expected that the number of days until the spawning could be further reduced. However, the effect of the fry breeding method according to the present invention resides in how securely the fry immediately after the hatching can be grown to a certain size rather than how the number of days until the spawning can be reduced. Judging from the behavior of the fry when they were fed with the foods, it was observed that the activity of the fry immediately after the hatching was sufficiently vivid.

At the time around the 11th day of the test start, all the powdery foods fed were consumed so that substantially no residual food was needed to be removed. As the present tests were long term breeding tests within a closed system supposed to be used for the space experiments, the fry have been bred in the closed system until the time when the spawning was observed. But, in the general usage, at the stage when the body length exceeds a certain level (about 10 mm in the case of medaka), it is considered practical that the fry are moved into a large size open type water tank. This is for the reason that, if the body length exceeds a certain level, volume of the breeding area per fish becomes important rather than the dissolved oxygen concentration.

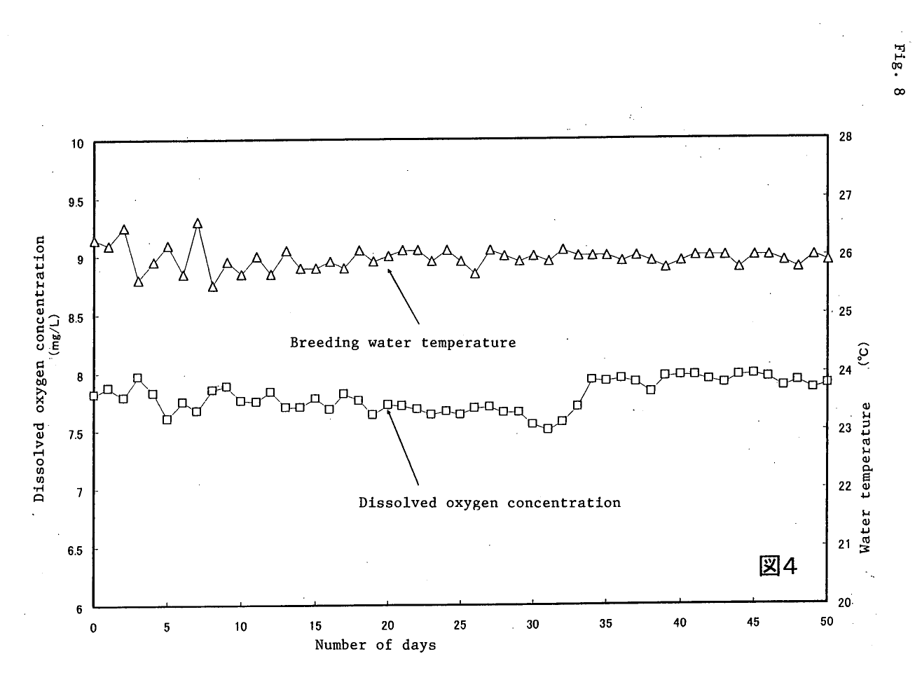

The data of measurements of the dissolved oxygen concentration and temperature of the breeding water in the present tests are shown in FIG. 8. It is found that, through the period of the present tests, the dissolved oxygen concentration is maintained at the value of as high as 7.5 to 8.0 mg/L. Incidentally, the saturated dissolved oxygen concentration at the water temperature set value of 26° C. in the present tests is 7.99 mg/L.

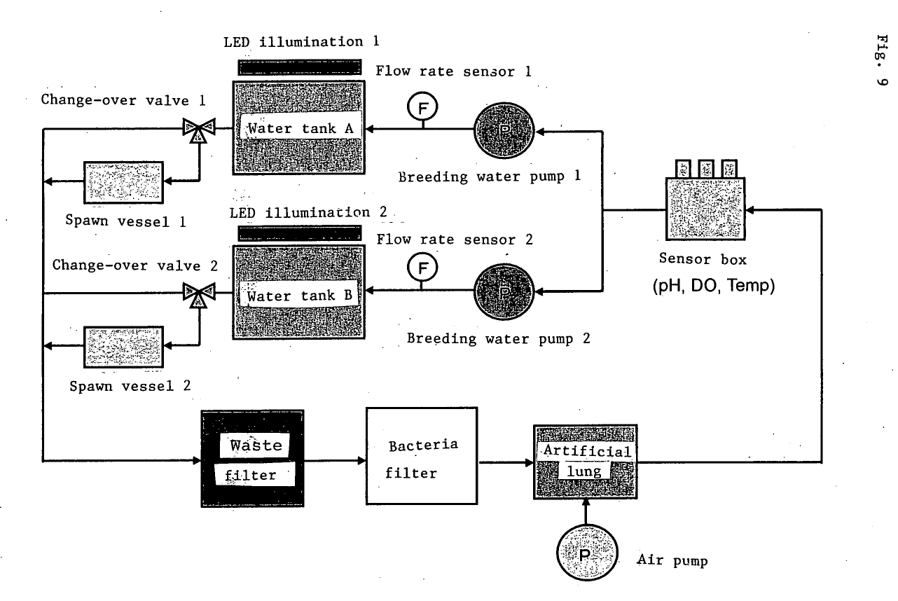

A set-up of the present tests is shown in FIG. 9. The present tests are supposed as the space experiments and thus, in a water tank of as small as about 700 cc, 10 fry of the medaka immediately after the hatching have been bred to become grown fish.

While one breeding water circulating system is commonly used, the present system is different from the above described embodiments such that two breeding water tanks A, B are arranged in parallel with each other, a bacteria filter is used for maintaining the water quality because the breeding period is long, spawn vessels 1, 2 are connected to outlets of the breeding water tanks A, B, respectively, for collecting spawns, the breeding water temperature is controlled by the outside environment temperature, etc. Nevertheless, the breeding water of the high dissolved oxygen concentration prepared by the artificial lung is supplied into the closed type water tank and thereby the effect of the present invention can be sufficiently obtained. For reference purpose, outlines of the test conditions are shown in the following Table 1:

| | |
|---|---|
| Circulation system: | 1 closed circulation system, total circulated |
| | water quantity 4.4 liter |
| Water tank: | 2 tanks of inner volume of about 700 cc each |
| Breeding water | 26° C. (controlled by the outside environment |
| temperature: | temperature) |
| Breeding water flow rate: | 0.1 liter/min (average linear flow velocity |
| | in the tank: 0.02 cm/sec) |
| Illumination: | About 1000 Lux (at the water tank bottom), |
| | 14 Hr bright/10 Hr dark |
| Food: | Powdery food (Otohime β1 made by Nisshin |
| | Shiryo Co.), 3 times/day |
| | Solid food (Orihime made by Kyorin Co.), |
| | appropriate times/day starting from the |
| | 22nd day of the test start |
| Oxygen supply: | Gas exchange by an artificial lung (EL 2000 α |
| | made by Dai Nippon Ink Kagaku Co.) |
| Water quality | Ammonia treatment by a bacteria filter |
| maintenance: | (nitrating bacteria) |
| Waste removal: | Waste removal by a waste filter (filter cloth, |
| | activated carbon) |
| Monitoring of the | Breeding water temperature, flow rate, pH, |
| breeding environment: | DO |

1. A fry breeding method comprising the step of quickly, safely and securely growing fry by circulating breeding water prepared to have a high dissolved oxygen concentration in a closed type water tank.

2. A fry breeding method as claimed in claim 1, wherein said breeding water is prepared to have a high dissolved oxygen concentration of 80% or more of a saturated value of the dissolved oxygen concentration.

3. A fry breeding apparatus comprising a means continuously supplying breeding water into a closed type breeding water tank to flow therein in a flow velocity of 0.1 to 3 mm/second and a means enhancing a dissolved oxygen concentration of said breeding water.

4. A fry breeding apparatus as claimed in claim 3, wherein said closed type breeding water tank is a closed type breeding water tank having its inlet side and outlet side provided with an isolating means, such as a mesh, etc., preventing fry from passing therethrough.

5. A fry breeding apparatus as claimed in claim 3, wherein a filter device filtering off residual foods, etc. of said breeding water is provided downstream of said breeding water tank.

6. A fry breeding apparatus as claimed in claim 3, wherein said means enhancing the dissolved oxygen concentration of said breeding water is an artificial lung and an entire system of said breeding water is made in a closed type so as to be usable even in a micro-gravity condition in the space.

7. A fry breeding apparatus as claimed in claim 4, wherein a filter device filtering off residual foods, etc. of said breeding water is provided downstream of said breeding water tank.

8. A fry breeding apparatus as claimed in claim 4, wherein said means enhancing the dissolved oxygen concentration of said breeding water is an artificial lung and an entire system of said breeding water is made in a closed type so as to be usable even in a micro-gravity condition in the space.
